(19) United States
(12) Patent Application Publication
(10) Pub. No.: US 2016/0177091 A1
(43) Pub. Date: Jun. 23, 2016

(54) POLYOXYMETHYLENE COPOLYMER SUITED FOR USE IN LIQUID SYSTEMS

(71) Applicant: Ticona GmbH, Sulzbach (DE)

(72) Inventors: Michael Haubs, Bad Kreuznach (DE); Klaus Kurz, Kelsterbach (DE)

(21) Appl. No.: 14/971,534

(22) Filed: Dec. 16, 2015

Related U.S. Application Data
(60) Provisional application No. 62/093,259, filed on Dec. 17, 2014.

(51) Int. Cl. C08L 71/00; C10M 145/26

(52) U.S. Cl. CPC C08L 71/00; C10M 145/26

(57) ABSTRACT

A water soluble polyoxymethylene copolymer is described. In one embodiment, the polyoxymethylene copolymer is a liquid at 35° C. and is water soluble. The polyoxymethylene copolymer may have a comonomer content of greater than about 60% by weight, such as greater than about 70% by weight, such as greater than about 80% by weight. The copolymer is usually formed using a chain transfer agent. The polyoxymethylene copolymer can be formed so as to have a relatively low molecular weight and have a relatively great amount of end groups or terminal groups. For instance, the copolymer may contain end groups in an amount greater than 300 mmol/kg.

### RELATED APPLICATIONS

The present application is based on and claims priority to U.S. Provisional Patent application Ser. No. 62/093,259, filed on Dec. 17, 2014, which is incorporated herein by reference.

### BACKGROUND

Polyoxymethylene homopolymers and copolymers have long been known as versatile materials that can be used to mold many different parts and articles. Polyoxymethylene polymer molded articles, for instance, can be used as a substitute for metals because of their outstanding mechanical properties, such as high rigidity, hardness and strength. Polyoxymethylene polymers also have very good chemical resistance properties making them well suited for use where contact with organic solvents or fuels is required.

In the past, those skilled in the art have attempted to create polyoxymethylene polymers that are non-crystalline at room temperature or above. These polymers were produced in order to be blended with conventional polyoxymethylene polymers to improve the impact properties of molded articles made with the blend. For instance, U.S. Pat. No. 4,788,258, which is incorporated herein by reference, discloses polyoxymethylene copolymers having a low glass transition temperature.

U.S. Pat. No. 7,030,207 to Tajima, which is also incorporated herein by reference, is directed to a polyacetal copolymer that has a high affinity to water. The polymer disclosed therein may be used as a heating medium or a lubricant.

The present disclosure is directed to producing polyoxymethylene polymers with unique characteristics and properties. In particular, the present disclosure is directed to producing polyoxymethylene polymers that are water miscible and/or water soluble. The creation of such polymers can dramatically expand the useful applications of polyoxymethylene polymers. For instance, as opposed to being used to producing rigid molded articles, the water miscible polyoxymethylene polymers may be used in emulsions and other liquid systems.

### SUMMARY

The present disclosure is generally directed to a process for producing polyoxymethylene polymers that are generally soluble in water at room temperature. The present disclosure is also directed to polymer compositions containing the polyoxymethylene polymers.

In one embodiment, the present disclosure is directed to a polyoxymethylene polymer composition comprising a polyoxymethylene copolymer containing comonomer units in an amount greater than about 60% by weight, such as in an amount greater than about 70% by weight, such as in an amount greater than about 80% by weight. In one embodiment, the comonomer units may comprise 1,3-dioxolane units. In addition, the copolymer contains end groups in an amount greater than about 300 mmol/kg, such as in an amount greater than about 400 mmol/kg. The copolymer contains hemiformal terminal groups in an amount less than about 100 mmol/kg, such as in an amount less than about 60 mmol/kg. The copolymer has a molecular weight (expressed as number average molecular weight Mn) of from about 500 to about 7,000, such as from about 500 to about 5,000, such as from about 1,000 to about 4,000.

Polyoxymethylene copolymers made according to the present disclosure are water miscible and have a water uptake of less than about 5%, such as less than about 3%, such as less than about 1%, such as less than about 0.8% when tested at 25° C. and at 50% relative humidity. The polyoxymethylene copolymer is a liquid at a temperature of 40° C., and in one embodiment, is a liquid at 30° C. The melting point of the polymer can be less than about 50° C., such as less than about 40° C., such as less than about 35° C.

Polyoxymethylene copolymers made in accordance with the present disclosure have many unique and diverse applications and uses. For instance, the polyoxymethylene copolymers of the present disclosure may be incorporated into various emulsions. The polyoxymethylene copolymer may serve as a lubricant and the like. In addition, the liquid polyoxymethylene polymers may be used as hydraulic fluids.

In order to form the polyoxymethylene copolymer, trioxane, 1,3-dioxolane, a chain transfer agent, and a catalyst can be reacted together. The chain transfer agent may comprise methylal, butylal, ethylene glycol, diethylene glycol, triethylene glycol or mixtures thereof. The catalyst may comprise triflic acid, perchloric acid, boron trifluoride or its etherates, heteropolyacids or mixtures thereof.

Other features and aspects of the present disclosure are discussed in greater detail below.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to polyoxymethylene polymers that are water miscible. In one embodiment, for instance, the polyoxymethylene polymer can be water soluble. In the past, polyoxymethylene polymers were produced that had a high affinity to water. In the past, the total number of terminal groups on the formed polymers was limited. The present inventors, however, discovered that by increasing the number of terminal groups or end groups, polyoxymethylene polymers can be formed that have unique properties and, in fact, improved properties in certain applications.

The polyoxymethylene polymers of the present disclosure, for instance, are not only water miscible or water soluble, but have excellent water uptake properties. The polymers, for instance, can have a water uptake of less than about 5%, such as less than about 3%, such as less than about 1%, such as even less than about 0.8% when tested at 25° C. and at 50% relative humidity. The water uptake is generally greater than about 0.05%.

Polyoxymethylene polymers made in accordance with the present disclosure can have a relatively low melting point and can have a relatively low crystallization point. The melting point (as measured by DSC) can generally be less than about 45° C., such as less than about 40° C., such as less than about 35° C. The melting point is generally greater than about −10° C., such as greater than about 0° C., such as greater than about 10° C.

Through the process of the present disclosure, a polyoxymethylene polymer is produced that is soluble in water. The polymer can be made so as to be a liquid at ambient temperatures. When combined with water, a clear solution can be produced that is completely stable for extended periods of time. For instance, when the polymer is present in a 90 wt. % solution in water, the resulting solution can be clear at room temperature and can remain clear for at least two months, such as at least 30 days without showing any signs of separation or cloudiness.

The preparation of polyoxymethylene polymers according to the present disclosure can be carried out by polymerization of polyoxymethylene-forming monomers, such as a mixture of trioxane and at least one comonomer such as 1,3-dioxolane. The polymerization can be effected in bulk, as a melt process, as a solution polymerization process, or as a mixture of the above.

More particularly, the polyoxymethylene copolymers of the present disclosure can be produced by the cationic polymerization of cyclic formals or cyclic acetals in the presence of comonomers. The cyclic acetal may comprise 1,3,5-trioxane (trioxane), tetroxane, or mixtures thereof. Comonomers that may be used to form the polymer include ethylene oxide or other cyclic ethers or cyclic acetals. Such comonomers include in addition to ethylene oxide, propylene 1,2-oxide, butylene 1,2-oxide, butylene 1,3-oxide, 1,3-dioxane, 1,3-dioxolane, 1,3-dioxepane, 1,3,6-trioxocane, 1,3,6,9-tetraoxacycloundecane and mixtures thereof. In one embodiment, the comonomer comprises 1,3-dioxolane (dioxolane).

Conventional polyoxymethylene copolymers typically have a comonomer content in the range of from about 3% to about 6%. The comonomer content of polymers made according to the present disclosure, however, have a comonomer content of greater than about 60% by weight, such as greater than about 65% by weight, such as greater than about 70% by weight, such as greater than about 75% by weight, such as greater than even about 80% by weight. The comonomer content is generally less than about 99% by weight, such as less than about 90% by weight, such as less than about 85% by weight.

Polymerization is conducted by the addition of an initiator to a reaction mixture comprising cyclic formals, comonomers, and a chain transfer agent. The initiator not only starts the polymerization reaction, but also influences the molecular weight distribution through chain transfer and chain termination reactions.

The initiator can comprise a cationic initiator. Suitable cationic initiators include compounds that can be used to react cyclic acetals or cyclic ethers to form —CH₂—O— units. Initiators that may be used include strong Bronstedt and Lewis acids. Examples of initiators include perchloric acid, heteropolyacids, triflic acid which is also known as trifluoromethanesulfonic acid or a boron compound. The boron compound may comprise a boron halide, such as boron trifluoride. Acid anhydrides can also be used. In some applications, esters can initiate the polymerization of cyclic ethers. One such ester is methyl-(trifluoromethane) sulfonate.

In general, an initiator should be selected that is active in small concentrations. In this manner, after deactivation of the initiator at the end of polymerization, it is not necessary to separate the deactivated initiator from the polymer. In one embodiment, a mixture of initiators may be used.

The concentration of the initiator is typically from about 0.01 ppm to about 500 ppm by weight based on the weight of the monomers. In one embodiment, the initiator is present at a concentration of from about 0.1 ppm to about 20 ppm. The initiator may be first combined with an inert solvent and then added to the monomers. For instance, the initiator may be first combined with the chain transfer agent, which can serve as a solvent.

Various different chain transfer agents may be used to form the polymers of the present disclosure. In one embodiment, the chain transfer agent may comprise an acetal of formaldehyde. The acetal of formaldehyde, for instance, can have the following formula:

R¹—(O—CH₂)_{q}—O—R²

in which R¹ and R² represent independently of each other alkyl groups, preferably methyl, and q is an integer from 1 to 100.

R¹ and R² are preferably independently of one another linear or branched C₁-C₆-alkyl radicals which are more preferably straight chain.

Particularly preferably R¹ and R², independently of each other are ethyl, propyl or butyl, in particular methyl.

q is an integer which preferably ranges from 1 to 9, more preferably q is 1.

Most preferably the acetal of formaldehyde is methylal.

The method for the preparation of oxymethylene polymers can alternatively be conducted in the presence of a polyhydric alcohol. Especially, if high hydroxyl-containing polyoxymethylene polymers are desired, the method is preferably carried out in the presence of a polyhydric alcohol. The term “high hydroxyl-containing” polyoxymethylene polymer is meant to refer to a polyoxymethylene having a ratio of hydroxyl end groups to total end groups greater than 50%, and preferably greater than 80% in the molecule. The quantity of hydroxyl groups in the molecules are determined, for example, by the technique described in Applied Polymer Science, 38, 87 (1989) which is expressly incorporated hereinto by reference.

Examples of polyhydric alcohols which can be used in the method of the present invention are preferably selected from the group consisting of partial esters of polyhydric alcohols, adducts of polyhydric alcohols or partial esters thereof with alkylene oxide, hydroxylated glycidyl ethers and glycidyl esters, hydroxylated cyclic acetals.

More preferably, the polyhydric alcohol is selected from glycerine, trimethylolpropane, pentaerythritol, diglycerine, sorbitan, sorbitol, sorbitan monoester and diglycerin monoester and adducts thereof with alkylene oxide such as ethylene oxide, propylene oxide or butylenes oxide. In one embodiment, the polymerization process is conducted in the presence of the polyhydric alcohol ethylene glycol.

The amount of chain transfer agent present during the polymerization reaction can vary depending upon the desired result. In general, the chain transfer agent can be present in an amount from about 50 ppm to about 20 weight %, based on the weight of the monomers. For instance, the chain transfer agent can be present in an amount greater than about 500 ppm, such as in an amount greater than about 1000 ppm, such as in an amount greater than about 10,000 ppm, such as in an amount greater than about 2 weight %, such as in an amount greater than about 4 weight %. The chain transfer agent is generally present in an amount less than about 15 weight %, such as in an amount less than about 10 weight %, such as in an amount less than about 8 weight %, based on the monomer mixture.

In order to form the polymer, in one embodiment, the initiator can be first combined with the chain transfer agent, such as methylal. The initiator and the chain transfer agent can be added to the monomers while stirring. The reactants can be combined together at any suitable temperature. Of particular advantage, the reaction can occur at atmospheric pressure and at ambient temperature. For instance, at atmospheric pressure (such as 1 ATM), the reaction can be carried out at a temperature of generally greater than about 20° C. and generally less than about 120° C. In one embodiment, lower temperatures are maintained during the entire reaction. For instance, the reaction can occur at a temperature of less than about 50° C., such as less than about 45° C., such as less than about 40° C., such as less than about 35° C., such as less than about 30° C. In one particular embodiment, the temperature is maintained between about 20° C. and 35° C., such as from about 25° C. to about 30° C. during polymerization.

In other embodiments, higher pressures and/or temperatures may be used. For instance, the temperature can be from about 60° C. to about 100° C. At higher temperatures, however, the polymerization conditions may be harder to control.

The polymerization can be terminated by adding a basic compound to the reaction mixture. For instance, in one embodiment, a deactivator is added to the reaction mixture for deactivating and terminating the polymerization. Typical deactivators are organic bases. Examples of deactivators include triethylamine or melamine. In one embodiment, the deactivator comprises a solution of triethylamine and methylal. The deactivator is added in an amount sufficient to terminate the polymerization.

Once polymerization has been terminated, residual monomers may optionally be removed. For instance, vacuum distillation can remove residual monomers. During vacuum distillation thermally unstable hemiacetal endgroups will split off formaldehyde to yield thermally stable hydroxyalkyl-endgroups.

In general, the resulting copolymer should contain hemiformal terminal groups in minimal amounts. For instance, the hemiformal terminal group content can be less than about 60 mmol/kg, such as less than about 50 mmol/kg, such as less than about 40 mmol/kg, such as less than about 30 mmol/kg, such as less than about 20 mmol/kg. Use of the chain transfer agent can minimize the amount of hemiformal terminal groups. In one embodiment, unstable terminal hemiacetal groups that are present may be removed by hydrolysis.

By controlling the reaction conditions, the relative amounts of the different reactants, and the use of a deactivator, a polyoxymethylene copolymer can be formed that has a relatively low molecular weight, is a liquid at ambient temperature, and is water miscible and/or water soluble.

The resulting polymer, for instance, can have a molecular weight of generally less than about 7,000 g/mol, such as less than about 5,000 g/mol (number average molecular weight). The number average molecular weight is generally greater than about 500 g/mol, such as greater than about 1,000 g/mol, such as greater than about 2,000 g/mol. In one embodiment, the molecular weight is from about 1,000 g/mol to about 5,000 g/mol, such as from about 1,500 g/mol to about 6000 g/mol. The resulting polymer has a unique combination of characteristics and can be used in numerous and different applications. For instance, in one embodiment, the resulting polyoxymethylene copolymer can be used as an additive for forming emulsions.

In one embodiment, the polyoxymethylene copolymer can be incorporated into a lubricant composition.

In yet another embodiment, the polyoxymethylene copolymer may be incorporated into a hydraulic liquid.

The present disclosure may be better understood with reference to the following examples.

### EXAMPLES

### Example 1

To a mixture of 900 g of trioxane, 300 g of dioxolane and 36 g of methylal at 25° C. was added 0.4 g of a 1 wt % solution of triflic acid in methylal with stirring. The mixture was kept between 25° C. and 30° C. by external cooling. After a reaction time of 3 hours 100 mg of a 10 wt % solution of triethylamine in methylal were added to terminate the polymerization. Residual monomers were removed through vacuum distillation in a rotary evaporator at 100° C. and 100 mbar. 980 g of a clear liquid (980 g) remained.

The melting point was 32° C. as measured by DSC.

The crystallization point was 7° C.

The water uptake of the liquid polymer at 25° C. and 50% relative humidity was 0.6 wt %.

A 90 wt % solution of the polymer in water was clear at room temperature and remained so for several weeks. The viscosity of this 90 wt % solution was 73 mPas at 40° C.

### Example 2

Example 1 was repeated, except that 3 g of a 0.5 wt % solution of phosphoro tungsten acid in dimethyladipate was used as the initiator. The properties of the resulting polymer were identical to the polymer from Example 1 within experimental error.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polyoxymethylene polymer composition comprising a polyoxymethylene copolymer containing 1,3-dioxolane units in an amount greater than about 60% by weight, the copolymer containing end groups in an amount greater than 300 mmol/kg.

2. A polyoxymethylene polymer composition as defined in claim 1, wherein the copolymer contains hemiformal terminal groups in an amount less than about 60 mmol/kg.

3. A polyoxymethylene polymer composition as defined in claim 1, wherein the polymer is formed from the reaction product of trioxane, 1,3-dioxolane, a chain transfer agent, and a catalyst.

4. A polyoxymethylene polymer composition as defined in claim 3, wherein the polymer has a molecular weight of from about 500 to about 7,000.

5. A polyoxymethylene polymer composition as defined in claim 3, wherein the chain transfer agent comprises methylal, butylal, ethylene glycol, diethylene glycol, triethylene glycol or mixtures thereof.

6. A polyoxymethylene polymer composition as defined in claim 2, wherein the catalyst comprises triflic acid, perchloric acid, boron trifluoride, or mixtures thereof.

7. A polyoxymethylene polymer composition as defined in claim 1, wherein the copolymer contains dioxolane units in an amount from about 55% by weight to about 85% by weight.

8. A polyoxymethylene polymer composition as defined in claim 1, wherein the polyoxymethylene copolymer is water miscible.

9. A polyoxymethylene polymer composition as defined in claim 1, wherein the polyoxymethylene copolymer has a water uptake at 25° C. and at 50% relative humidity of less than about 2%.

10. A polyoxymethylene polymer composition as defined in claim 1, wherein the polyoxymethylene copolymer contains end groups in an amount greater than about 400 mmol/kg and contains hemiformal terminal groups in an amount less than about 50 mmol/kg.

11. A polyoxymethylene polymer composition as defined in claim 1, wherein the polyoxymethylene copolymer is water soluble at room temperature.

12. A polyoxymethylene polymer composition as defined in claim 1, wherein the polyoxymethylene copolymer has a crystallization point of less than about 12° C.

13. An emulsion containing the polyoxymethylene polymer composition as defined in claim 1.

14. A lubricant composition containing the polyoxymethylene polymer composition as defined in claim 1.

15. A hydraulic fluid composition comprising the polyoxymethylene polymer composition as defined in claim 1.
